(19) United States
(12) Patent Application Publication
(10) Pub. No.: US 2014/0199624 A1
(43) Pub. Date: Jul. 17, 2014

(54) METHOD OF PREPARING ENVIRONMENT-FRIENDLY TONER

(71) Applicants: Eui Hyun Ryu, Daejeon (KR); Il Sun Hwang, Daejeon (KR); Il Hyuk Kim, Daejeon (KR); Sung Yul Kim, Daejeon (KR)

(72) Inventors: Eui Hyun Ryu, Daejeon (KR); Il Sun Hwang, Daejeon (KR); Il Hyuk Kim, Daejeon (KR); Sung Yul Kim, Daejeon (KR)

(21) Appl. No.: 14/008,809

(22) PCT Filed: Apr. 1, 2011
(86) PCT No.: PCT/KR11/02299

§ 371 Date: Sep. 30, 2013

(51) Int. Cl. G03G 9/08; G03G 9/087

(52) U.S. Cl. CPC G03G 9/081; G03G 9/08755
USPC 430/109.4; 430/137.14

(57) ABSTRACT

A method of preparing a toner. A toner having a low residual VOC content, a narrow particle size distribution, excellent fixing properties at low temperature, and high image quality may be prepared using the method by which a polyester resin dispersion is prepared by adding ingredients to a single reactor in a predetermined order.

### TECHNICAL FIELD

The present invention relates to a method for preparing a toner, and more particularly, to a method for preparing an environment-friendly toner having a low residual volatile organic compound (VOC) content, a narrow particle size distribution, excellent fixing properties at low temperature, and high image quality.

### BACKGROUND ART

In general, toner is prepared by mixing a thermoplastic resin, as a binder resin, with a colorant, a release agent, or the like. In addition, inorganic fine metal particles such as silica or a titanium oxide may be added to the toner as external additives in order for the toner to have fluidity or to improve its physical properties such as charge is controlling properties or cleaning properties. Toner is prepared by using a physical method such as pulverization or a chemical method such as suspension polymerization and emulsion aggregation.

Since a method of preparing toner using polymerization, which is a chemical method, involves radical polymerization, only a vinyl-based resin can be used as a binder resin. However, since the polymerization cannot be completely terminated, unreacted monomers, a surfactant, etc. may remain in toner particles, thereby resulting in deteriorating charge properties.

A polyester resin has higher pigment dispersibility, higher transparency, a lower fixing temperature, and a narrower range of glass transition temperature than a vinyl-based resin such as a styrene-acrylic copolymer resin. Thus, a polyester resin may be suitable for a binder resin of high-speed printers or color printers.

Korean Patent Publication No. 2003-0038317 discloses a method of preparing a toner including dissolving a polyester resin, a colorant, a charge control agent, and a releasing agent in an organic solvent, dissolving a surfactant and other additives in an aqueous solvent, mixing the two solutions and emulsifying the mixture, and collecting powder by cooling and washing the emulsion mixture. According to this method, it is difficult to remove the organic solvent, the residual organic solvent deteriorates general physical properties of the toner, and a residual volatile organic compound (VOC) content may be increased in the toner.

Thus, a method of preparing toner in which an organic solvent is not used or efficiently removed may be used. For example, toner may be prepared using a dispersion prepared by dispersing a polyester resin in an aqueous dispersion medium.

Japanese Patent publication No. hei 10-39545 discloses a method of preparing a toner including preparing a wax and pigment dispersion by dispersing a wax and a pigment in water, adding the wax and pigment dispersion to a self-dispersing sodium sulfonated polyester emulsion, adding an alkali halide solution thereto to aggregate toner particles, and coalescing the toner particles. Although a toner composition may be prepared without using an organic solvent and a surfactant according to this method, the dispersion stability of the pigment is not sufficient since the pigment is dispersed using the sodium sulfonated polyester, so that the pigment aggregate and color reproducibility of toner deteriorate. Also, the toner composition has unstable charging properties is depending on environmental conditions.

### DISCLOSURE OF THE INVENTION

### Technical Problem

The present invention provides a method for preparing a toner having a very low residual volatile organic compound (VOC) content by reducing the amount of VOCs including an organic solvent in a polyester resin dispersion solution, excellent fixing properties at low temperature, and high gloss.

### Technical Solution

According to an aspect of the present invention, there is a provided method for preparing a toner. The method including:

adding a polyester resin and an organic solvent to a polar solvent including a surfactant and a dispersion stabilizer while stirring to prepare a mixture;

heating the reaction mixture and distillating to prepare a polyester resin dispersion solution, in which an amount of the residual organic solvent is less than 10,000 wtppm; the mixture may be heated at higher temperature than a boiling point of the organic solvent in the prepared polyester resin dispersion solution;

mixing the polyester resin dispersion solution with a colorant dispersion solution and a wax dispersion solution;

aggregating toner particles by adding an coagulant to the reaction mixture; and

coalescing the aggregated toner particles.

The method may include further washing and drying the toner particles after the coalescing process.

The surfactant may be an anionic surfactant.

According to other aspects of the present invention, there is a provided toner having an amount of residual volatile organic compounds (VOCs) less than 100 wtppm.

### Advantageous Effects

Environment-friendly toner particles having a narrow particle size distribution, excellent fixing properties at low temperature, high gloss, and the low level of residual volatile organic compound (VOC) contents may be prepared by using the method of preparing a toner according to the present invention.

### BRIEF DESCRIPTION OF THE DRAWINGS

FIG. 1 is a graph illustrating a flow curve of a sample obtained using a temperature raising method using a load extrusion type capillary rheometer.

### BEST MODE FOR CARRYING OUT THE INVENTION

Hereinafter, the present invention will now be described more fully with reference to exemplary embodiments of the invention.

A method for preparing a toner according to an embodiment of the present invention includes: adding a polyester resin and an organic solvent to a polar solvent including a surfactant and a dispersion stabilizer while stirring to prepare a reaction mixture;

heating the reaction mixture and distillating to prepare a polyester resin dispersion solution, in which an amount of the residual organic solvent is less than 10,000 wtppm;

mixing the polyester resin dispersion solution with a colorant dispersion solution and a wax dispersion solution;

aggregating toner particles by adding an coagulant to the reaction mixture; and

coalescing the aggregated toner particles.

The method may further include washing and drying the coalesced toner particles.

The method for preparing the toner will be described in more detail using sub-processes: (A) a dispersion solution-preparing process, (B) an aggregating process, (C) a freezing and coalescing process, and (D) a washing and drying process.

(1) Dispersion Solution-Preparing Process

The dispersion solution-preparing process includes three sub-processes of a polyester resin dispersion solution-preparing process, a colorant dispersion solution-preparing process, and a wax dispersion solution-preparing process.

A polyester resin and an organic solvent are added to a polar solvent including a surfactant and a dispersion stabilizer. Then, the reaction mixture is heated and distillated to prepare a polyester resin dispersion solution in which an amount of the is residual organic solvent is less than 10,000 wtppm.

The polyester resin dispersion solution may be prepared in a single reactor to simplify the preparation process and to reduce reaction time for the dispersion solution preparation. In addition, the particle size distribution in the dispersion solution may become narrower since the polyester resin in the dispersion solution is uniformly neutralized by the dispersion stabilizer.

Generally, a polyester resin dispersion is prepared by completely dissolving a polyester resin in an organic solvent, and then mixing the solution with the other ingredients. However, the polyester resin dispersion solution according to the current embodiment is prepared by sequentially adding the polyester resin and the organic solvent in the order described above so that the organic solvent may easily be removed.

The polar solvent, including the surfactant and the dispersion stabilizer, may be prepared by sequentially or simultaneously adding the surfactant and the dispersion stabilizer to the polar solvent.

The surfactant, the dispersion stabilizer, the polyester resin, and the organic solvent may be added to the polar solvent in the order described above.

In the preparation of the polyester resin dispersion solution, the reaction mixture may be heated up to higher temperature than the boiling point of the organic solvent. The heating may be performed for 3 to 15 hours. The level of residual VOC contents in the toner may be minimized by reducing the amount of residual organic solvent in the polyester resin dispersion solution up to less than 10,000 wtppm by distillating. The content of the organic solvent in the polyester resin dispersion solution may be less than 5,000 wtppm.

The particle size in the polyester resin dispersion solution may be in the range of 50 to 300 nm.

The polar solvent may be water, methanol, ethanol, butanol, acetonitrile, acetone, ethyl acetate, and the like. For example, the polar solvent may be water. The amount of the polar solvent in the reaction mixture may be in the range of 150 to 500 parts by weight based on 100 parts of polyester resin by weight.

A weight-average molecular weight of the polyester resin used herein may be in the range of 5,000 to 50,000. If the weight-average molecular weight of the polyester resin is less than 5,000, storage properties and fixing properties of the toner may deteriorate. On the other hand, if the weight-average molecular weight of the polyester resin is greater than 50,000, fixing properties of the toner may deteriorate.

The polyester resin may also have a poly dispersity index (PDI) in the range of 2 to 10, a peak molecular weight (Max peak position (Mp)) measured using a gel permeation chromatography (GPC) in the range of 1,000 to 10,000, and a T_{1/2} obtained using a load extrusion type capillary rheometer in the range of 100° C. to 140° C. The Mp measured using the GPC is a molecular weight calculated from a peak value of an elution curve obtained by using the GPC. Conditions for the GPC are as follows.

Device: Toyo-Soda Industry Inc., HLC8020

Column: Toyo-Soda Industry Inc., Three TSKgelGMHXLs (column size: 7.8 mm (ID)×30.0 cm (L)) connected in series.

Oven temperature: 40° C.

Eluant: THF

The Mp was obtained using a calibration curve obtained using a standard polystyrene at a time corresponding to the peak value of the obtained elution curve.

As the standard polystyrene for making the calibration curve, products of Toyo-Soda Industry Inc. were used. For example, TSK standard, A-500 (molecular weight: 5.0×10²), A-2500 (molecular weight: 2.74×10³), F-2 (molecular weight: 1.96×10⁴), F-20 (molecular weight: 1.9×10⁵), F-40 (molecular weight: 3.55×10⁵), F-80 (molecular weight: 7.06×10⁵), F-128 (molecular weight: 1.09×10⁶), F-288 (molecular weight: 2.89×10⁶), F-700 (molecular weight: 6.77×10⁶), and F-2000 (molecular weight: 2.0×10⁷) were used.

In addition, the peak value of the elution curve is a maximum value of the elution curve. If the elution curve has two or more maximum values, the highest maximum value is used as the peak value. The eluant may be any solvent dissolving the polyester resin besides THF without limitation, for example, chloroform.

The load extrusion type capillary rheometer, which is a device simply measuring performance of a resin, such as thermal characteristics and viscosity, measures viscous resistance while melted materials are passing through a capillary. For example, a flow tester CFT-500 manufactured by Shimadzu Corporation may be used. The performance of the resin may be measured using this device and a temperature raising method by which temperature is increased at a constant rate as a processing time passes. While a sample is transformed from a solid zone, through a transition zone and a rubber-phases elastic zone, to a flow zone, the performance may consecutively be measured. Using this device, shear rate and viscosity may be measured at all temperatures in the flow zone.

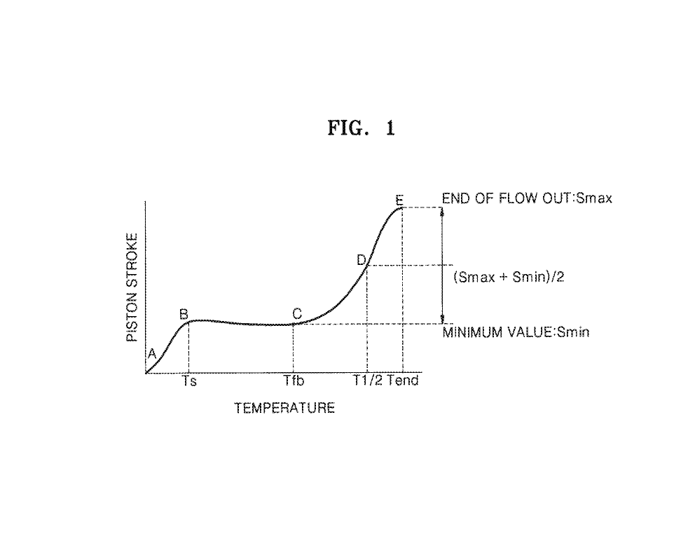

FIG. 1 is a graph illustrating a flow curve of a sample obtained using a temperature raising method using a load extrusion type capillary rheometer.

AB region (softening curve) represents a stage in which a sample is deformed under compression load so that internal voids are gradually reduced.

Point B represents a temperature at which the internal voids disappear so that the sample has one transparent state or phase with a non-uniform stress distribution and a uniform appearance. Point B is an inflection point between the solid zone and the transition zone. This temperature is defined as a softening temperature (Ts).

BC region (stop curve) is a region in which a position of a piston is not significantly changed within a limited time period and the sample begins to flow from a die. The sample includes a rubber-phase elastic zone. A crystalline polymer has a short rubber-phase elastic zone and a Ts similar to a temperature at which the sample begins to flow, as described below.

Point C represents s a temperature at which the sample beings to flow from the die of a flow meter due to the reduction of viscosity. This temperature is defined as a flow beginning temperature (Tfb).

CDE region (flow out curve) is a region in which the sample begins to flow from the die as a non-heated viscous flow.

The melting point (T_{1/2}) is a temperature corresponding to a half piston stroke of the flow meter between the temperature at which the sample begins to flow out Tfb and the temperature at which the flow is stopped Tend.

In addition, a glass transition temperature (Tg) of the polyester resin may be in the range of 40 to 80° C., for example, 50 to 75° C. if the Tg is less than 40° C., storage stability of toner prepared using polyester resin particles may deteriorate. On the other hand, if the Tg is greater than 80° C., offsets may occur, especially in a color printing.

The polyester resin not having a sulfonate group may be used.

The polyester resin may be prepared by polycondensation of an acid component and an alcohol component. Polybasic carboxylic acid is used as the acid component, and polyhydric alcohol is used as the alcohol component.

Examples of the polyhydric alcohol component may be polyoxyethylene-(2,0)-2,2-bis(4-hydroxyphenyl)propane, polyoxypropylene-(2,0)-2,2-bis(4-hydroxyphenyl)propane, polyoxypropylene-(2,2)-polyoxyethylene-(2,0)-2,2-bis(4-hydroxyphenyl)propane, polyoxyethylene-(2,3)-2,2-bis(4-hydroxyphenyl)propane, polyoxypropylene-(6)-2,2-bis(4-hydroxyphenyl)propane, polyoxypropylene-(2,3)-2,2-bis(4-hydroxyphenyl)propane, polyoxypropylene-(2,4)-2,2-bis(4-hydroxyphenyl)propane, polyoxypropylene-(3,3)-2,2-bis(4-hydroxyphenyl)propane, polyoxyethylene-(6)-2,2-bis(4-hydroxyphenyl)propane, ethylene glycol, 1,3-propylene glycol, 1,2-propylene glycol, 1,4-butylene glycol, 1,3-butylene glycol, glycerol, and polyoxypropylene. Examples of the polybasic carboxylic acid include any aromatic polybasic acid and/or alkyl esters thereof, which are commonly used to prepare a polyester resin. Examples of the aromatic polybasic acid are terephthalic acid, isophthalic acid, trimellitic acid, pyromellitic acid, 1,2,4-cyclohexane tricarboxylic acid, 2,5,7-naphthalene tricarboxylic acid, 1,2,4-naphthalene tricarboxylic acid, 1,2,5-hexane tricarboxylic acid, 1,2,7,8-octane tetracarboxylic acid, and/or alkyl esters thereof, wherein the alkyl group may be a methyl group, an ethyl group, a propyl group and a butyl group. The aromatic polybasic acid and alkyl esters thereof may be used alone or in a combination of at least two thereof.

The acid value of the polyester resin may be in the range of 5 to 50, for example, 10 to 20.

The organic solvent used in the polyester resin dispersion may include at least one selected from the group consisting of methyl acetate, ethyl acetate, isopropyl acetate, methyl ethyl ketone, dimethyl ether, diethyl ether, 1,1-dichloroethane, 1,2-dichloroethane, dichloromethane, and chloroform, but is not limited thereto. The amount of the organic solvent may be in the range of 150 to 500 parts by weight based on 100 parts by weight of the polyester resin.

The surfactant used in the polyester resin dispersion may be an anionic surfactant. The amount of the surfactant may be in the range of 1 to 4 parts by weight based on 100 parts by weight of the polyester resin.

The dispersion stabilizer used in the polyester resin dispersion may be a monovalent cation-containing base and may include at least one selected from the group consisting of potassium hydroxide, sodium hydroxide, sodium carbonate, sodium bicarbonate, lithium hydroxide, potassium carbonate, ammonia, triethylamine, triethanolamine, pyridine, ammonium hydroxide, diphenylamine, and derivatives thereof, and poly(ethyleneamine) and derivatives thereof. For example, the dispersion stabilizer may be sodium hydroxide or potassium hydroxide.

The amount of the dispersion stabilizer is related to the acid value of the polyester resin. As the acid value increases, the amount of the dispersion stabilizer increases so that a dispersion having a narrow particle size distribution may be prepared. The amount of the dispersion stabilizer may be in the range of 2 to 3 equivalents based on the acid value of the polyester resin.

The colorant dispersion may be prepared by dispersing a colorant in water using a dispersant such as a surfactant. The dispersant used in water may be an anionic surfactant and nonionic surfactant, for example, an anionic surfactant. The dispersant helps to disperse a pigment in water and reduces a particle diameter of the pigment dispersed in toner, thereby improving properties of the toner. The remaining dispersant may be removed during a following washing process.

The colorant may be selected from pigments that are commonly and commercially used, such as a black pigment, a cyan pigment, a magenta pigment, a yellow pigment, and any mixture thereof.

The amount of the colorant may be any amount sufficient to color toner and form a visible image by development, and may be in the range of 3 to 15 parts by weight based on 100 parts by weight of the polyester resin. If the amount of the colorant is less than 3 parts by weight, coloring effects may not be sufficient. On the other hand, if the amount of the colorant is greater than 15 parts by weight, a sufficient frictional charge amount may not be obtained due to low electric resistance, thereby causing contamination.

The wax dispersion may be prepared by dispersing a natural or synthetic wax in water.

The wax may be any known wax, for example, a natural wax such as carnauba wax and rice wax, a synthetic wax such as polypropylene wax and polyethylene wax, a petroleum-based wax such as montan wax, an alcohol-based wax, and an ester-based wax. The wax may be used alone or in combination of at least two thereof.

When the wax is dispersed in water, a dispersion may be prepared using a surfactant or a dispersion stabilizer and a dispersion device such as a high-pressure or high-speed homogenizer. The amount of the wax may be in the range of 0.5 to 20 parts by weight, for example, 1 to 10 parts by weight based on 100 parts by weight of the polyester resin.

(B) Aggregating Process

The dispersions prepared in the dispersion-preparing process are mixed and an aggregating agent and an acid are added thereto while stirring the mixture to aggregate toner particles. The aggregating process may be performed at room temperature or at a temperature around a Tg of the polyester resin. Toner particles having a uniform particle diameter and a uniform shape may be prepared by applying a mechanical shearing force using a stirrer when the mixture of the dispersions is stirred.

The aggregating agent may be any known aggregating agent, for example, an electrolyte or an organic material having a polarity opposite to that of the pigment. For example, sodium chloride that is easily washed by pure water and has high solubility in water may also be used. The amount of the aggregating agent may be in the range of 0.3 to 6% by weight, for example, 1.0 to 5% by weight, based on the total solid content. If the amount of the aggregating agent is less than 0.3% by weight, the toner particles may not be aggregated. On the other hand, if the amount of the aggregating agent is greater than 6% by weight, the aggregated particles may be too large.

Even though the amount of the aggregating agent is in the range of 0.3 to 6% by weight based on the total solid content in ingredients added for the aggregation, the pH is controlled by adding the dispersion stabilizer and an acid since the dispersion stabilizer used in the preparation of the polyester resin dispersion functions as an auxiliary agent during the aggregation.

An acid may be added to the aggregating process to control the pH, and the pH during the aggregating process may be in the range of 4.5 to 6.5.

The aggregating process may be performed by stirring the reaction mixture at 1.0 to 7.0 m/sec at a temperature in the range of 40 to 60° C.

(C) Freezing and Coalescing Process

In order to freeze the aggregated toner particles, the temperature of the reaction mixture is maintained, and the pH is increased to 10.

In this regard, an inorganic base such as NaOH, KOH, or LiOH is added thereto to increase the pH.

Then, the particle diameter and shape of the aggregated toner particles are uniformized by heating the mixture including the toner particles. The mixture may be heated to a temperature higher than the Tg of the polyester resin such that the particle diameter of the toner particles is in the range of 1 to 20 μm. Accordingly, the toner particles may have a uniform particle diameter and shape.

Surface properties of the toner particles may be improved by heating the mixture to a temperature higher than the Tg of the polyester resin. Before the mixture is heated to a temperature higher than the Tg of the polyester, the polyester resin dispersion or a polystyrene butyl acrylate latex is added to the mixture in order to coat the toner particles obtained in the aggregating process, so that the pigment or the wax contained in the toner particles cannot leak and the toner particles become strong. In this regard, the additionally added polyester resin dispersion or polystyrene butyl acrylate latex may be a resin dispersion having the same properties (e.g., Tg and molecular weight) as the polyester resin dispersion used in the previous stage or a resin dispersion having a higher Tg and a greater molecular weight than those of the polyester resin dispersion used in the previous stage. The resin dispersion having a higher Tg and greater molecular weight than those of the polyester resin dispersion used in the previous stage may have a Tg in the range of 60 to 85° C. and a molecular weight in the range of 10,000 to 300,000. If the toner particles prepared in the aggregating process are coated with the additionally added resin dispersion, the particle size of the toner particles may increase. In order to prevent the increase of the particle size of the toner particles, a surfactant may be added thereto, the pH may be controlled, or a coalescing process may be performed by heating the mixture to a temperature higher than the Tg of the polyester is resin.

(D) Washing and Drying Process

The toner particles obtained in the coalescing process are washed with water and dried. In this process, the mixture including the toner is cooled to room temperature and filtered. Then, the filtrate is removed and the toner is washed with water. The washing process may be performed using pure water having an ionic conductivity equal to or less than 10 μS/cm. The toner may be washed until the filtrate of the toner has an ionic conductivity equal to or less than 50 μS/cm. The washing of the toner using pure water may be performed in a batch or consecutive type. The washing of the toner using pure water is performed in order to remove unnecessary components such as impurities that may influence charging characteristics of the toner and aggregating agents that are not involved in the aggregation except for tone components.

If an inorganic salt of a monovalent metal is used as the aggregating agent, re-aggregation of the toner particles caused by re-activation of the inorganic salt according to the pH change during the washing process is prevented. Since the inorganic salt of the monovalent metal has far greater solubility in water compared to an inorganic salt of a multivalent metal, it is easily removed during the washing process so that the amount of the inorganic salt of the monovalent metal remaining in the toner is significantly reduced, so that the toner particles have low melt viscosity and excellent fixing properties.

The toner obtained from the washing process is dried using a fluidized bed dryer, a flash jet dryer, or the like. External additives may also be added to the dried toner.

According to the method of preparing a toner, according to the current embodiment, toner particles having a residual VOC level less than 100 wtppm may be prepared by using a mixture of the polyester resin dispersion having a low residual organic solvent content and a wax dispersion and a pigment dispersion which do not include an organic solvent.

Hereinafter, one or more embodiments will be described in detail with reference to the following examples. However, these examples are not intended to limit the purpose and scope of the invention.

### Preparation Example 1

### Synthesis of Polyester Resin 1

A 3 L reactor equipped with a stirrer, a nitrogen gas inlet, a thermometer, and a cooler was installed in an oil bath in which the oil is a heat transfer medium. 45 g of terephthalic acid, 39 g of isophthalic acid, 75 g of 1,2-propylene glycol, and 3 g of trimellitic acid were added to the reactor, and tetrabutyl titanate was added thereto as a catalyst at a ratio of 500 ppm with respect to the total weight of the monomers. The reactor was heated to 150° C. while stirring at 150 rpm. The reactor was maintained at the same temperature for 6 hours and heated to 220° C. Then, the pressure of the reactor was reduced to 0.1 torr in order to remove byproducts, and the reactor was maintained at the same pressure for 15 hours to obtain polyester resin 1.

### Preparation Example 2

### Synthesis of Polyester Resin 2

137 g of dimethyl terephthalate, 55 g of dimethyl isophthalate, 68 g of ethylene glycol, 175 g of a bisphenol A derivative including ethylene oxide, and 0.1 g of tetrabutoxy titanate, as a catalyst, were added to an autoclave equipped with a thermometer and a stirrer. The autoclave was maintained at a temperature in the range of 150 to 220° C. for 180 minutes to perform trans-esterification. Then, the autoclave was heated to 240° C., the pressure of the autoclave was gradually reduced to 10 mmHg for 30 minutes, and then the autoclave was maintained at the same pressure for 70 minutes. The inside of the autoclave was replaced with nitrogen gas, the pressure thereof was adjusted to atmospheric pressure, and the autoclave was cooled to 200° C. Then, 2.0 g of trimellitic acid was added thereto, and the autoclave was maintained at the same pressure for 70 minutes to obtain polyester resin 2.

### Preparation Example 3

### Synthesis of Polyester Resin 3

215 g of terephthalic acid, 485 g of isophthalic acid, 468 g of 2,2-dimethyl-1,3-propane diol, 156 g of 1.5-pentane diol, and 0.41 g of tetrabutyl titanate, as a catalyst, were added to a reactor equipped with a stirrer, a condenser, and a thermometer. The reactor was maintained at a temperature in the range of 160° C. to 230° C. for 4 hours to perform esterification. The pressure of the reactor was gradually reduced to 5 mmHg for 20 minutes, and the reactor was maintained at 260° C. in a vacuum of 0.3 mmHg or less for 40 minutes to perform polycondensation. The reactor was cooled to 220° C. in a nitrogen atmosphere. Then, 23 g of trimellitic acid was added thereto, and the reactor was maintained at the same temperature for 30 minutes to obtain polyester resin 3.

### Preparation Example 4

### Synthesis of Polyester Resin 4

38 g of 1,5-naphthalene dicarboxylate methyl ester, 96 g of dimethyl terephthalate, 58 g of dimethyl isophthalate, 136 g of ethylene glycol, and 0.1 g of tetrabutoxy titanate, as a catalyst, were added to an autoclave equipped with a thermometer and a stirrer. The autoclave was maintained at a temperature in the range of 150 to 220° C. for 180 minutes to perform trans-esterification. Then, the autoclave was heated to 240° C., the pressure of the autoclave was gradually reduced to 10 mmHg for 30 minutes, and then the autoclave was maintained at the same temperature for 70 minutes. The inside of the autoclave was replaced with nitrogen gas, the pressure thereof was adjusted to atmospheric pressure, and the autoclave was cooled to 200° C. to obtain polyester resin 4.

### Preparation Example 5

### Synthesis of Polyester Resin 5

A 3 L reactor equipped with a stirrer, a thermometer, a condenser, and a nitrogen gas inlet was installed in an oil bath. 97 g of dimethyl terephthalate, 96 g of dimethyl isophthalate, 0.15 g of dimethyl 5-sulfoisophthalate sodium salt, 175 g of 1,2-propylene glycol, and 4.0 g of trimellitic acid were added to the reactor. Then, tetrabutyl titanate was added thereto as a polymerization catalyst at a ratio of 500 ppm with respect to the total weight of the monomers. The reactor was heated to 150° C. while stirring at 100 rpm and maintained at the same temperature for about 5 hours. When methanol, as a byproduct of the esterification, was not collected from the condenser, the reactor was heated to 220° C. and the pressure of the reactor was reduced to 0.1 torr. Then, the reactor was maintained at the same temperature for 15 hours to obtain polyester resin 5.

Glass Transition Temperature (Tg, ° C.)

A Tg of a sample was measured using a differential scanning calorimeter (DSC)(manufactured by Netzsch Co.) by heating the sample from 20 to 200° C. at 10° C./min, rapidly cooling the sample to 10° C. at 20° C./min, and heating the sample at 10° C./min.

Acid Value

An acid value (mgKOH/g) was measured by dissolving a resin in dichloromethane, cooling the solution, and titrating the solution with a 0.1N KOH methyl alcohol solution.

Weight Average Molecular Weight, Mp

A weight average molecular weight of a binder resin was measured by GPC using a calibration curve obtained using a polystyrene standard sample.

A Mp was obtained from a standard polystyrene at a time corresponding to the peak value of an elution curve obtained using GPC. In this regard, the peak value of the elution curve is a maximum value of the elution curve. If the elution curve has two or more maximum values, the highest value is used as the peak value. In addition, a signal strength of a GPC curve at Mp represents a difference between the signal strength at Mp and the signal strength of a base line, and a signal strength of the GPC curve at a molecular weight of 100,000 l (M100,000) represents a difference between the signal strength at the molecular weight of 100,000 and the signal strength of the base line. The unit of the signal strength is electrical potential (mV).

Device: Toyo-Soda Industry Inc., HLC8020

Column: Toyo-Soda Industry Inc., Three TSKgelGMHXLs (column size: 7.8 mm (ID)×30.0 cm (L)) connected in series.

Oven temperature: 40° C.

Eluant: THF

Concentration of Sample: 4 mg/10 ml

Conditions for Filtration: Filter a sample solution using a 0.45 μm Teflon™ membrane filter

Flow Rate: 1 ml/min

Supply Amount: 0.1 ml

Detector: RI

Standard polystyrene for making the calibration curve: Toyo-Soda Industry Inc. TSK standard, A-500 (molecular weight: 5.0×10²), A-2500 (molecular weight: 2.74×10³), F-2 (molecular weight: 1.96×10⁴), F-20 (molecular weight: 1.9×10⁵), F-40 (molecular weight: 3.55×10⁵), F-80 (molecular weight: 7.06×10⁵), F-128 (molecular weight: 1.09×10⁶), F-288 (molecular weight: 2.89×10⁶), F-700 (molecular weight: 6.77×10⁶), and F-2000 (molecular weight: 2.0×10⁷).

A T_{1/2} according to the current embodiment was obtained using the load extrusion type capillary rheometer under the following conditions:

Piston Unit Area: 1 cm²

Pressure of cylinder: 0.98 Mpa

Length of Die: 1 mm, Diameter of Die Hole: 0.5 mm

Measurement Initiation Temperature: 90° C.

Temperature Raising Rate: 3° C./min

Weight of Sample: 1.5 g

TABLE 1

| | | Acid value | Weight average | | |
|---|---|---|---|---|---|
| | Tg | (mgKOH/g) | molecular weight | Mp | T_{1/2} (° C.) |
| Preparation | 66 | 11 | 18,000 | 5100 | 125 |
| Example 1 | | | | | |
| Preparation | 62 | 15 | 25,000 | 6500 | 124 |
| Example 2 | | | | | |
| Preparation | 67 | 17 | 38,000 | 7000 | 128 |
| Example 3 | | | | | |
| Preparation | 65 | 14 | 16,000 | 4100 | 120 |
| Example 4 | | | | | |
| Preparation | 80 | 8 | 50,000 | 7800 | 135 |
| Example 5 | | | | | |

### Preparation Example 6

### Preparation of Polyester Resin Dispersion 1

46 g (2.5 equivalents with respect to the acid value of a polyester resin) of a 4 wt % sodium hydroxide solution, as a dispersion stabilizer, 6.67 g of a surfactant (dowfax, Dow Corning company, at a ratio of 1% by weight based on the amount of the polyester resin), and 958 g of water were added to a 3 L reactor equipped with a thermometer and an impeller stirrer. 300 g of the polyester resin 1 in a solid state was added thereto, and 500 g of methyl ethyl ketone was added thereto. Then, the mixture was refluxed at 70° C. for 1 hour, and organic solvents were removed while purging with nitrogen at 80° C. for more than 4 hours. As a result, polyester resin dispersion 1 was obtained.

### Preparation Example 7

### Preparation of Polyester Resin Dispersion 2

Polyester resin dispersion 2 was obtained in the same manner as in Preparation Example 6, except that 54 g (2.5 equivalents with respect to the acid value of the polyester resin) of the 4 wt % sodium hydroxide solution was used as a dispersion stabilizer instead of using 46 g thereof and the polyester resin 2 was used instead of the polyester resin 1.

### Preparation Example 8

### Preparation of Polyester Resin Dispersion 3

Polyester resin dispersion 3 was obtained in the same manner as in Preparation Example 6, except that 59 g (2.5 equivalents with respect to the acid value of the polyester resin) of the 4 wt % sodium hydroxide solution was used as a dispersion stabilizer instead of using 46 g thereof and the polyester resin 3 was used instead of the polyester resin 1.

### Preparation Example 9

### Preparation of Polyester Resin Dispersion 4

Polyester resin dispersion 4 was obtained in the same manner as in Preparation Example 6, except that 52 g (2.5 equivalents with respect to the acid value of the polyester resin) of the 4 wt % sodium hydroxide solution was used as a dispersion stabilizer instead of using 46 g thereof and the polyester resin 4 was used instead of the polyester resin 1.

### Preparation Example 10

### Preparation of Polyester Resin Dispersion 5

Polyester resin dispersion 5 was obtained in the same manner as in Preparation Example 6, except that 30 g (2.5 equivalents with respect to the acid value of the polyester resin) of the 4 wt % sodium hydroxide solution was used as a dispersion stabilizer instead of using 46 g thereof and the polyester resin 5 was used instead of the polyester resin 1.

### Preparation Example 11

### Preparation of Polyester Resin Dispersion 6

300 g of a polyester resin and 600 g of MEK were added to a 3 L reactor equipped with a thermometer and an impeller stirrer, and the reactor was heated to 70° C. while stirring to dissolve the polyester resin. 600 g of water and 32 g of KOH (5% solution), as a dispersion stabilizer, were added to the reactor, and the reactor was stirred using a TEKMAR stirrer at level 1. The reactor was stirred for about 10 minutes, and then the MEK was removed therefrom. The resultant was cooled to room temperature, and the particle size thereof was regulated using a microfluidizer to obtain a polyester resin dispersion 6.

Particle size, residual organic solvent content, and solid content of the polyester resin dispersions prepared according to Preparation Examples 6 to 11 are shown in Table 2 below. The residual organic solvent content was measured using a headspace GC-MS. In particular, a sample was prepared by adding 5 ml of a resin dispersion to a 20 ml vial. Then, the vial was sealed using a cap and connected to a headspace autosampler. The residual organic solvent content was measured by flowing hydrogen at 40 ml/min, air at 400 ml/min, and He at 20 ml/min, analyzed using a flame ionization detector (FID), and identified using a standard curve drawn by using toluene having a known concentration.

An average particle diameter was measured using a microtrack analyzer (NIKKISO, Co., Ltd., Japan).

TABLE 2

| | Particle size in | Residual | |
|---|---|---|---|
| | polyester resin | organic solvent | Solid |
| | dispersion (nm) | content (wtppm) | content (%) |
| Preparation | 150 | 120 | 24.1 |
| Example 6 | | | |
| Preparation | 180 | 200 | 24.5 |
| Example 7 | | | |
| Preparation | 140 | 3000 | 24.2 |
| Example 8 | | | |
| Preparation | 200 | 4700 | 24.8 |
| Example 9 | | | |
| Preparation | 140 | 5800 | 24.6 |
| Example 10 | | | |
| Preparation | 150 | 10500 | 24.4 |
| Example 11 | | | |

### Preparation Example 12

### Preparation of Pigment Dispersion

540 g of a cyan pigment (Daicolor Pigment MFG. Co., Ltd., Japan, ECB303), 27 g of a surfactant (Dowfax 2A1), and 2,450 g of distilled water were added to a 4 L reactor equipped with a stirrer, a thermometer, and a condenser, and the reactor was slowly stirred for about 10 hours to prepare a pre-dispersion.

Then, the pre-dispersion was dispersed four times at 1500 bar using an Ultimaizer (Armstec Ind. Co., Ltd.) until the particle size became 200 nm or less. As a result, a cyan pigment dispersion was obtained.

After the dispersion, the particle size of the cyan pigment was measured using a Multisizer 2000 (Malvern), and a D50 (volume average particle size) was 170 nm.

### Preparation Example 13

### Preparation of Wax Dispersion

50 g of paraffin wax (NIPPON SEIRO, HNP10, melting point: 72° C.), 10 g of an anionic surfactant (SDBS, Rhodia), and 160 g of ion-exchanged water were added to a jacket portion, and the mixture was dispersed at 95° C. for 30 minutes using a homogenizer (IKA). Then, the mixture was added to a pressure-ejecting homogenizer (Japan Precision Instruments Inc.) and dispersed at 90° C. for about 20 minutes to obtain a wax dispersion having a volume average particle size (D50(v)) of 230 nm (obtained using a Microtrac 252 manufactured by Microtrac Inc.)

### Example 1

88% by weight of the polyester resin dispersion prepared in Preparation Example 6, 5% by weight of the pigment dispersion prepared in Preparation Example 12, and 7% by weight of the wax dispersion prepared in Preparation Example 13 were mixed to prepare a mixture. These amounts are based on solid content. In this regard, the total solid content was adjusted to 13% by weight using pure water. 53 g of a 10% sodium chloride solution and 10 g of a 0.3 M nitric acid solution were added to the mixture, and the resultant was stirred using a blend type stirrer at 10,000 rpm and heated to 52° C. The mixture was stirred for about 3 hours to perform aggregation and heated to 95° C. to coalesce toner particles. When the circularity of the toner particles is greater than 0.985, the mixture was cooled to 60° C., and the pH of the mixture was adjusted to 9 by adding a 1 N sodium hydroxide solution. When the temperature of the mixture reached room temperature, course particles were filtered using a mesh having a size of 20 μm, and the aggregated particles were washed three times with water. Then, a 0.3 M nitric acid solution was added thereto to adjust the pH to 1.5, and the resultant was washed three times with pure water and filtered. The filtrate was dried using a fluidized bed dryer to prepare black toner.

### Examples 2 to 6

Black toner was prepared in the same manner as in Example 1, except that each of the polyester resin dispersions prepared in Preparation Examples 7 to 10 were used instead of using the polyester resin dispersion prepared in Preparation Example 6.

### Comparative Example 1

### Preparation of Toner by Emulsion Aggregation

A 30 L reactor equipped with a stirrer, a thermometer, and a condenser was installed in an oil bath in which the oil is a heat transfer medium. 6,600 g of distilled water and 32 g of a surfactant (Dowfax 2A1) were added to the reactor, and the reactor was heated to 70° C. and stirred at 100 rpm. Then, an emulsion mixture including monomers, i.e., 8,380 g of styrene, 3,220 g of butyl acrylate, 370 g of 2-carboxyethyl acrylate, and 226 g of 1,10-decanediol diacrylate, 5,075 g of distilled water, 226 g of the surfactant (Dowfax 2A1), 530 g of polyethylene glycol ethyl ether methacrylate, as a macro monomer, and 188 g of 1-dodecanethiol, as a chain transfer agent, was stirred at 400 to 500 rpm for 30 minutes using a disc-type impeller. Then, the emulsion mixture was gradually added to the reactor for 1 hour. The reactor was maintained at the same temperature for about 8 hours and gradually cooled to room temperature to complete the reaction.

A Tg of the binder resin measured using a DSC after the reaction was completed was 62° C. A number average molecular weight of the binder resin measured by GPC using a polystyrene standard sample was 50,000.

84% by weight of the latex, 7% by weight of the pigment dispersion prepared in Preparation Example 12, and 9% by weight of the wax dispersion prepared in Preparation Example 13 were mixed, wherein these amounts are based on solid content. Then, the total solid content was adjusted to 13% by weight using pure water. 4.2 g of a 10% PAC solution and 10 g of a 0.3 M nitric acid solution were added to the mixture, and the resultant was stirred using a blend type stirrer at 10,000 rpm and heated to 52° C. The mixture was stirred for about 3 hours to perform aggregation, and then a 1 N NaOH was added thereto to adjust the pH to 10, and 12 g of EDTA was added to inactivate multivalent metal salt. Then, the mixture was heated to 96° C. to coalesce toner particles. When the circularity of the toner particles is greater than 0.985, the mixture was cooled to 60° C., and the pH of the mixture was adjusted to 9 by adding a 1 N sodium hydroxide solution. When the temperature of the mixture reached room temperature, course particles were filtered using a mesh having a size of 20 μm, and the aggregated particles were washed three times with water. Then, a 0.3 M nitric acid solution was added thereto to adjust the pH to 1.5, and the resultant was washed three times with pure water and filtered. The filtrate was dried using a fluidized bed dryer to prepare black toner.

### Comparative Example 2

### Preparation of Toner by Emulsion Aggregation Using Reversed-phase Resin Dispersion

(1) Preparation of Polyester Resin

0.5 mol of dimethyl terephthalate, 0.47 mol of dimethyl isophthalate, 0.03 mol of dimethyl 5-sulfoisophthalate sodium salt, 2.3 mol of 1,2-propylene glycol, and 0.02 mol of trimellitic acid were added to a reactor equipped with a thermometer, a stirrer, a cooler, and a nitrogen gas inlet. Then, tetrabutyl titanate was added thereto as a polymerization catalyst at a ratio of 500 ppm with respect to the total weight of the monomers. The reactor was heated to 150° C. while stirring at 100 rpm and maintained for about 5 hours. While esterification reaction is performed, methanol is produced as a byproduct. When the byproduct was not collected from the cooler, the reactor was heated to 220° C. Then, the pressure of the reactor was reduced to 0.1 torr in order to remove byproducts, and the reactor was maintained at the same temperature for 15 hours at the same pressure.

A Tg of the polyester resin measured using a DSC after the reaction was completed was 65° C. As a result of dissolving the polyester resin in tetrahydrofuran (THF), it was identified that insoluble gel components were completely dissolved. The polyester resin had an acid value of 5 mgKOH/g, a number average molecular weight of 4,500, and a PDI of 3.5.

(2) Preparation of Cyan Pigment Master Batch

The synthesized polyester resin and a blue pigment (C.I. pigment blue 15:3, manufactured by DIC) were mixed in a weight ratio of 6:4. Then, 50% by weight of ethyl acetate based on the weight of the polymer was added thereto, and the mixture was heated to about 60° C. and stirred using a kneader. Then, while the mixture was stirred at a speed of 50 rpm using a twin extruder having a vacuum device, ethyl acetate as a solvent was removed using the vacuum device to obtain a cyan pigment master batch.

(3) Preparation of Cyan Toner

85 g of the prepared polyester resin, 10 g of the cyan master batch, 2 g of a charge control agent (E-88, Orient Chemical, Japan), 4 g of paraffin wax (SX-70, Max Chemical, Korea), and 150 g of methyl ethyl ketone (Aldrich, U.S.A.) were added to a reactor equipped with an impeller stirrer and a cooler. The mixture was stirred, heated to 75° C. while refluxing, and mixed for 10 hours. When the mixture had sufficient fluidity, it was further stirred at 500 rpm for 2 hours to prepare a dispersion mixture.

400 g of distilled water, 7 g of a neutral surfactant (Tween 20, Aldrich), and 6 g of sodium dodecyl sulfate (Junsei Chemical Co. Japan) were added to another reactor to prepare a dispersion medium, and the reactor was stirred, heated to 75° C. while refluxing, and stirred at 500 rpm for 1 hour. The dispersion mixture was added to the dispersion medium. This mixture was stirred at 1000 rpm for 1 hour at the same temperature to prepare a resin mixture dispersion. The reactor was stirred at 300 rpm at the same temperature. Then, methyl ethyl ketone was collected from the cooler while the reactor was maintained at 90° C. under a partially reduced pressure. After 4 hours, it was identified that the methyl ethyl ketone had been completely removed by measuring the amount of collected methyl ethyl ketone, and then the reactor was cooled. Toner particles were obtained using a filter commonly used in the art. The toner particles were washed four times by repeating a process including a dispersing process in distilled water and a filtering process for removing the surfactant, and dried.

### Comparative Example 3

Black toner was prepared in the same manner as in Example 1, except that the polyester resin dispersion prepared in Preparation Example 11 was used instead of the polyester resin dispersion prepared in Preparation Example 6.

Average particle diameters, circularity, image quality, gloss, fixing temperature, and storage properties of the toner particles prepared in Examples 1 to 6 and Comparative Examples 1 to 3, residual organic solvent contents in the resin dispersion, and residual VOC contents in toner were evaluated as follows, and the results are shown in Table 3 below.

Average Particle Diameter

The average particle diameter of the toner particles was measured using a Coulter Multiziser III (Backman Coulter, U.S.A.) in which an aperture of 100 μm was used, and 50,000 toner particles were measured.

Circularity

Circularity was measured by using an FPIA-3000 (manufactured by Sysmex, Japan). While measuring the circularity by using the FPIA-3000, samples were prepared by adding a suitable amount of surfactant to 50 to 100 ml of distilled water, adding 10 to 20 mg of toner particles thereto, and then dispersing the resultant in an ultrasonic disperser for 1 minute.

The circularity was automatically obtained from the FPIA-3000 according to the following Equation.

Circularity=2×(area×π)^{1/2}/perimeter

In this regard, the area indicates a projected area of the toner and the perimeter indicates a circumference of a circle having the same area as the projected toner. The circularity may be in the range of 0 to 1, wherein the closer the circularity is to 1, the more circular the toner is.

Image Quality

Image quality was evaluated by developing an image using a remodeled CP 2025(HP) that is a digital full color printer. Image density was measured using a Spectroeye (GretagMacbeth).

ok: Image density of 1.3 or higher

ng: Image density less than 1.3

Gloss

Gloss was evaluated by developing an image using a remodeled CP 2025(HP) that is a digital full color printer. Gloss was measured using a Spectroeye (GretagMacbeth).

ok: Gloss of 1.3 or higher

ng: Gloss less than 13

Storage Properties

5 g of toner was added to a 50 ml sample bottle and the bottle was stored in a chamber having a temperature of 50° C. and a humidity of 80% for 24 hours. The stored sample was left to sit at room temperature, and the degree of aggregation was identified with the naked eyes. Then, the amount of the sample remaining in a 100 μm sieve was measured. The sample was evaluated as ng if the amount is 10% or greater, and the sample was evaluated as ok if the amount is less than 10%.

Fixing Temperature

9.75 g of the prepared toner particles, 0.2 g of silica (TG 810G; Cabot Co.), and 0.05 g of silica (RX50, Degussa GmbH) were mixed to prepare toner particles. Using the toner particles, unfixed images in a 30 mm×40 mm solid state were collected from a Samsung CLP-510 printer. Then, the fixing properties of the unfixed images were evaluated while varying the temperature of a fixing roller at a fixing tester in which the fixing temperature could be controlled. A temperature range in which cold offsets or hot offsets do not occur was shown in Table 3 below.

Residual VOC Content in Toner

In order to measure the residual VOC content in solid-phase toner, a gas chromatography-mass spectrometry (GC-MS) having a thermo desorption system (TDS) capable of capturing volatile components of a solid-phase sample was used. In this regard, 10 mg of toner was placed at the center of a glass tube sealed with glass cotton, and the glass tube was installed in the TDS for a pre-treatment of the sample. The TDS was run at a temperature in the range of 40 to 200° C. at a rate of 60° C./min, and conditions for the GC-MS measurement are the same as those of a Headspace GC-MS.

TABLE 3

| | Average | | | | | | | | |
|---|---|---|---|---|---|---|---|---|---|
| | particle | | | | | | | Fixing | Residual VOC |
| | diameter | Image | | | | Storage | | temperature | content in |
| | (μm) | density | | Gloss | | properties | | range | toner (wtppm) |
| Example 1 | 6.2 | 1.4 | ok | 16 | ok | 6% | ok | 135~180° C. | 37 |
| Example 2 | 6.0 | 1.3 | ok | 14 | ok | 7% | ok | 140~170° C. | 24 |
| Example 3 | 6.8 | 1.3 | ok | 13 | ok | 8% | ok | 150~170° C. | 55 |
| Example 4 | 6.4 | 1.3 | ok | 13 | ok | 9% | ok | 150~190° C. | 21 |
| Example 5 | 6.4 | 1.3 | ok | 13 | ok | 15% | ng | 150~190° C. | 17 |
| Example 6 | 6.2 | 1.4 | ok | 13 | ok | 7% | ok | 140~170° C. | 43 |
| Comparative | 6.5 | 0.9 | ng | 5 | ng | 15% | ng | 160~200° C. | 780 |
| Example 1 | | | | | | | | | |
| Comparative | 7.7 | 1.0 | ng | 7 | ng | 25% | ng | 160~200° C. | 1000 |
| Example 2 | | | | | | | | | |
| Comparative | 7.3 | 1.1 | ng | 11 | ng | 20% | ng | 160~190° C. | 850 |
| Example 3 | | | | | | | | | |

As shown in Table 3, toner particles prepared using the method according to the present invention have a narrow particle size distribution, high gloss, excellent storage properties, and high image quality. It was identified that the residual VOC content in toner was significantly reduced to less than 100 wtppm.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of preparing a toner, the method comprising:
adding a polyester resin and an organic solvent to a polar solvent comprising a surfactant and a dispersion stabilizer while stirring;
heating the mixture to prepare a polyester resin dispersion, in which an amount of the residual organic solvent is less than 10,000 wtppm;
mixing the polyester resin dispersion with a colorant dispersion and a wax dispersion;
aggregating toner particles by adding an aggregating agent to the mixture; and
coalescing the aggregated toner particles.

2. The method of claim 1, wherein the mixture is heated to a temperature higher than a boiling point of the organic solvent in the preparing the polyester resin dispersion.

3. The method of claim 1, wherein the surfactant is an anionic surfactant.

4. The method of claim 1, wherein the dispersion stabilizer is a monovalent cation-containing base.

5. The method of claim 1, wherein the organic solvent comprises at least one selected from the group consisting of methyl acetate, ethyl acetate, isopropyl acetate, methyl ethyl ketone, dimethyl ether, diethyl ether, 1,1-dichloroethane, 1,2-dichloroethane, dichloromethane, and chloroform.

6. The method of claim 1, wherein the polyester resin has an acid value of 5 to 50 mgKOH/g, a weight-average molecular weight of 5,000 to 50,000, and a glass transition temperature (Tg) of 40 to 80° C.

7. The method of claim 1, wherein the polyester resin does not have a sulfonate group.

8. The method of claim 1, wherein the polar solvent is water.

9. The method of claim 1, wherein the amount of the organic solvent is in the range of 15 to 200 parts by weight based on 100 parts by weight of the polyester resin.

10. The method of claim 1, wherein the amount of the surfactant is in the range of 1 to 4 parts by weight based on 100 parts by weight of the polyester resin.

11. The method of claim 1, wherein the amount of the dispersion stabilizer is in the range of 2 to 3 equivalents based on the acid value of the polyester resin.

12. The method of claim 1, wherein the amount of the polar solvent is in the range of 3 to 5 parts by weight based on 100 parts by weight of the polyester resin.

13. The method of claim 1, further comprising washing and drying the toner particles after the coalescing process.

14. A toner prepared using a method according to claim 1, wherein the amount of residual volatile organic compounds (VOCs) is less than 100 wtppm.
